(19) United States
(12) Patent Application Publication
(10) Pub. No.: US 2022/0139229 A1
(43) Pub. Date: May 5, 2022

(54) PLATOONING CONTROLLER, SERVER, AND METHOD THEREOF

(71) Applicants: HYUNDAI MOTOR COMPANY, Seoul (KR); KIA CORPORATION, Seoul (KR)

(72) Inventor: Jeong Ki HONG, Seongnam-si (KR)

(73) Assignees: HYUNDAI MOTOR COMPANY, Seoul (KR); KIA CORPORATION, Seoul (KR)

(21) Appl. No.: 17/371,869

(22) Filed: Jul. 9, 2021

(30) Foreign Application Priority Data
Nov. 5, 2020 (KR) 10-2020-0147108

(51) Int. Cl. G08G 1/00; H04W 4/44; G06Q 30/00; G06Q 20/02; G06Q 20/12; B60W 30/17

(52) U.S. Cl. CPC G08G 1/22; H04W 4/44; G06Q 30/018; B60W 2556/45; G06Q 20/127; B60W 30/17; B60W 2554/802; G06Q 20/02

(57) ABSTRACT

A platooning controller, a server, and a method thereof are provided. The platooning controller includes a processor that automatically per forms a process for platooning and a storage storing data obtained by the processor and an algorithm run by the processor. The processor determines a probability that a forward vehicle will platoon during platooning and controls an inter-vehicle distance from the forward vehicle depending on a state of the forward vehicle, when it is possible for the forward vehicle to platoon and determines a probability that a following vehicle will platoon during the platooning and transmits platooning information to the following vehicle depending on a role of a host vehicle, when it is possible for the following vehicle to platoon.

### CROSS-REFERENCE TO RELATED APPLICATION

This application claims priority to and the benefit of Korean Patent Application No. 10-2020-0147108, filed on Nov. 05, 2020, the entire contents of which are incorporated herein by reference.

### FIELD

The present disclosure relates to a platooning controller, a server, and a method thereof, and more particularly, relates to technologies of interworking with an inter-vehicle distance controller during platooning to automatically perform platooning control.

### BACKGROUND

The statements in this section merely provide background information related to the present disclosure and may not constitute prior art.

Platooning is a technology in which a plurality of vehicles perform autonomous driving in the state where they are arranged at a specified interval in line. When the plurality of vehicles are platooning, a leading vehicle which is a vehicle located in the frontline of a string may control one or more following vehicles which follow the leading vehicle. The leading vehicle may maintain a gap between the plurality of vehicles included in the string and may exchange information about behaviors and situations of the plurality of vehicles included in the string using inter-vehicle communication. A gap between vehicles included in a platooning group may be adjusted during platooning depending on the intention of a driver.

For such platooning, a process such as platooning application, waiting, and approval may be performed through vehicle-to-everything (V2X) communication between vehicles.

As such, in the existing technology, as several processes go through for platooning, a user should respond to the processes and should identify and follow a route capable of performing platooning.

Furthermore, in the existing technology, the user pays or is paid predetermined costs to use a service and pays fixed costs irrespective of a platooning effect.

Thus the existing technology provides the platooning function to a vehicle equipped with a system capable of performing platooning and requires a driver of the vehicle (e.g., a commercial vehicle) to be familiar with a process of joining or releasing the platooning function. Such a vehicle generally travels in the same region along a planned route.

### SUMMARY

The present disclosure has been made to solve the above-mentioned problems occurring in the prior art advantages achieved by the prior art are maintained intact.

An aspect of the present disclosure provides a platooning controller for automatically performing all levels of a platooning service without additional manipulation of a driver based on platooning vehicle information previously registered with a server, a server and a method thereof.

Another aspect of the present disclosure provides a platooning controller for settling costs of a platooning service according to a role, a platooning time, fuel efficiency, or the like of each of platooning vehicles in real time and differentially paying costs to increase convenience of a user and platooning service efficiency, a server and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a platooning controller may include: a non-transitory memory storing data and instructions executable to process a platoon for vehicle; a processor that executes the instruction to automatically perform a process for platooning vehicles. The processor may determine a probability that a forward vehicle will platoon during platooning and control an inter-vehicle distance from the forward vehicle depending on a state of the forward vehicle, when it is possible for the forward vehicle to platoon, may determine a probability that a following vehicle will platoon during the platooning and transmit platooning information to the following vehicle depending on a role of a host vehicle, when it is possible for the following vehicle to platoon, and may automatically release the platooning, when a situation to release the platooning occurs.

In an exemplary form, the processor may calculate fuel efficiency according to a role and a platooning time in real time during the platooning.

In an exemplary form, the processor may automatically change a platooning route in real time depending on a change in the process for the platooning.

In an exemplary form, the processor may recognize a vehicle number of the forward vehicle and may transmit the recognized vehicle number to a server, when an inter-vehicle distance control function is enabled.

In an exemplary form, the processor may control the inter-vehicle distance from the forward vehicle based on information of the forward vehicle, the information being received from a server.

In an exemplary form, the processor may determine that the situation to release the platooning occur, in case of least one of when the forward vehicle makes a lane change, when the host vehicle makes a lane change, or when the forward vehicle or the following vehicle is not a vehicle above a predetermined rating.

In an exemplary form, the processor may release the platooning and may return an inter-vehicle distance control function to a normal mode, when the situation to release the platooning occurs.

In an exemplary form, the platooning controller may further include a sensing device that recognizes a vehicle number of the forward vehicle and delivers the recognized vehicle number to the processor and an interface that displays a platooning situation and costs according to use of a platooning service, the costs being received from a server.

According to another aspect of the present disclosure, a server may include a processor that performs management for platooning and a storage (e.g., a non-transitory memory) storing data obtained by the processor and an algorithm run by the processor. The processor may register a vehicle with a platooning service and may settle costs of the platooning service according to a platooning role and a platooning time based on platooning information received from platooning vehicles.

In an exemplary form, the platooning information may include at least one of fuel efficiency of each of the platooning vehicles, a platooning time of the platooning vehicle, braking information of the platooning vehicles, driving information of the platooning vehicles, a platooning start time of the platooning vehicles, or a platooning end time of the platooning vehicles.

In an exemplary form, the processor may determine whether it is possible for the vehicle to use a platooning service, when receiving a state of the vehicle from a user terminal.

In an exemplary form, the processor may receive a selection for a role of the vehicle during platooning from the user terminal, when it is possible for the vehicle to use the platooning service.

In an exemplary form, the processor may pay costs for a user of a leading vehicle, when the vehicle plays a role as the leading vehicle in a string and may be paid costs from a user of a following vehicle, when the vehicle plays a role as the following vehicle in the string.

In an exemplary form, the processor may receive and register vehicle information, role information during platooning, or a preferred rating of the vehicle from a user terminal and may determine a rating of the vehicle based on the vehicle information. The vehicle information may include at least one of sensor configuration of the vehicle, a shape of the vehicle, or fuel efficiency of the vehicle.

In an exemplary form, the processor may determine that it is impossible for the vehicle to use the platooning service, when a rating of the vehicle is less than or equal to the preferred rating received from the user terminal.

In an exemplary form, the processor may settle the costs of the platooning service based on fuel efficiency of a following vehicle and a platooning time of the following vehicle, when the vehicle is the following vehicle and may settle the costs of the platooning service based on fuel efficiency of a following vehicle behind a leading vehicle and a platooning time of the following vehicle, when the vehicle is the leading vehicle.

In an exemplary form, the processor may compare fuel efficiency upon normal driving with fuel efficiency upon platooning to calculate the costs of the platooning service.

In an exemplary form, the processor may settle the costs of the platooning service based on the number of times each of the roles of a leading vehicle and a following vehicle is performed and a platooning time taken to perform each of the roles of the leading vehicle and the following vehicle, when the vehicle plays both roles as the leading vehicle and the following vehicle.

In one form, the server may further include a communication device that shares the costs of the platooning service and the rating of the vehicle with the platooning vehicles.

According to another aspect of the present disclosure, a platooning control method may include registering a vehicle with a platooning service, settling costs of the platooning service according to a platooning role and a platooning time based on platooning information received from platooning vehicles, and sharing the costs of the platooning service with the platooning vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of a vehicle system including a platooning controller according to an exemplary form of the present disclosure;

FIG. 2 is a conceptual diagram illustrating information transmission between a platooning controller and an inter-vehicle distance controller according to an exemplary form of the present disclosure;

FIG. 3 is a signal sequence diagram illustrating a platooning control method according to another form of the present disclosure;

FIG. 4 is a flowchart illustrating a method for registering vehicle information according to an exemplary form of the present disclosure;

FIG. 5 is a flowchart illustrating a method for settling a platooning service according to an exemplary form of the present disclosure;

FIG. 6 is a flowchart illustrating a platooning control method by a following vehicle according to an exemplary form of the present disclosure;

FIG. 7 is a flowchart illustrating a platooning control method by a leading, vehicle according to another form of the present disclosure; and

FIG. 8 is a block diagram illustrating a computing system according to an exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding, parts and features.

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing the form of the present disclosure, a detailed description of well-known features or functions will be ruled out in order not to unnecessarily obscure the gist of the present disclosure.

In describing the components of the form according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having, such in the present application.

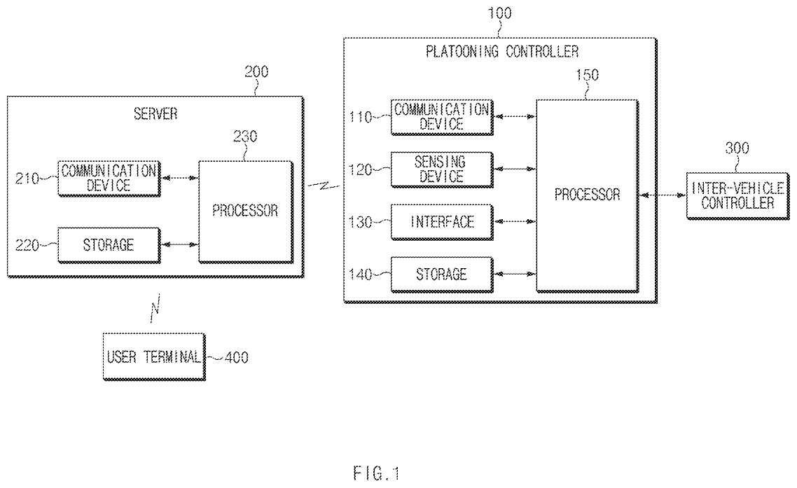

Hereinafter, forms of the present disclosure will be described in detail with reference to FIGS. 1 to 8.

A leading vehicle “LV” and a following vehicle “FV” included in a platooning group may perform platooning on the road. The leading vehicle LV and the following vehicle FV may travel while maintaining a specified distance. While driving, the leading vehicle LV or the following vehicle FV may adjust a distance between the leading vehicle LV and the following vehicle FV, The leading vehicle LV or the following vehicle FV may increase or decrease an inter-vehicle distance depending on manipulation of a driver.

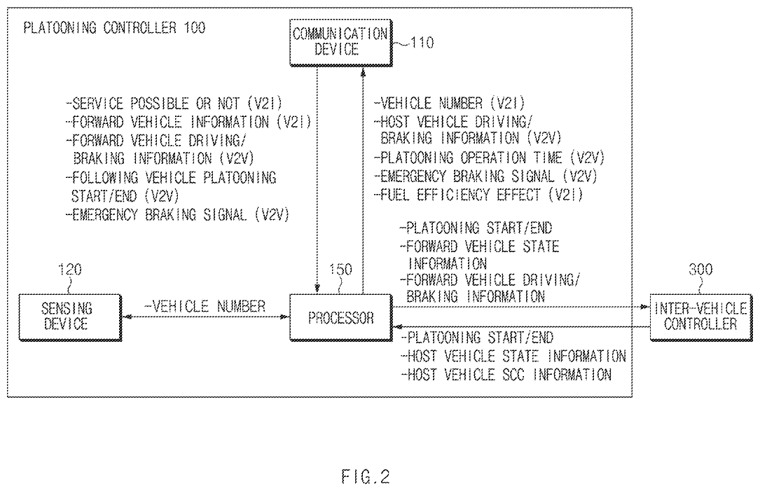

FIG. 1 is a block diagram illustrating a configuration of a vehicle system including a platooning controller according to an exemplary form of the present disclosure. FIG. 2 is a conceptual diagram illustrating information transmission between a platooning controller and an inter-vehicle distance controller according to an exemplary form of the present disclosure.

Referring to FIG. 1, the vehicle system may include an autonomous controller 100, a server 200, an inter-vehicle distance controller 300, and a user terminal 400.

The platooning controller 100 may automatically perform a process (e.g., joining, release, or the like) for platooning vehicles. In other words, the platooning controller 100 may determine if a forward vehicle can form a platoon, may control an inter-vehicle distance from the forward vehicle depending on rating of the forward vehicle. When it is possible for the forward vehicle to form the platoon, the platooning controller 100 may determine a probability that a following vehicle may form the platoon and transmit platooning information to the following vehicle depending on a role of a host vehicle. When it is possible for the following vehicle to form the platoon, and the platooning controller 100 may automatically release fine platooning when a situation to release the platooning occurs.

The platooning controller 100 according to one form of the present disclosure may be implemented in a vehicle. In this case, the platooning controller 100 may be integrally configured with control units in the vehicle or may be implemented as a separate device to be connected with the control units of the vehicle by a separate connection means.

Referring to FIG. 2, platooning controller 100 may include a communication device 110, a sensing device 120, an interface 130, a storage 140, and a processor 150.

The communication device 110 may be a hardware device implemented with various electronic circuits to transmit and receive a through a wireless or wired connection, which may communicate with the server 200 or other vehicles.

The communication device 110 may perform network communication in the vehicle using a network communication technology in the vehicle and may perform vehicle-to-infrastructure (V2I) communication with the server 200, an infrastructure, other vehicles, or the like outside the vehicle using a wireless Internet technology or a short range communication technology. Herein, the network communication technology in the vehicle may be to perform inter-vehicle communication through controller area network (CAN) communication, local interconnect network (LIN) communication, flex-ray communication, or the like. Furthermore, the wireless Internet technology may include wireless local area network (WLAN), wireless broadband (WiBro), wireless-fidelity (Wi-Fi), world interoperability for microwave access (WiMAX), or the like. Furthermore, the short range communication technology may include Bluetooth, ZigBee, ultra wideband (UWB), radio frequency identification (RFID), infrared data association (IrDA), or the like.

As an example, the communication device 110 may perform vehicle-to-vehicle (V2V) communication and V2I communication between platooning vehicles to share platooning information. In this case, the platooning information may include information such as a platooning speed, an inter-vehicle distance, a destination, a route, platooning start or end information, state information of platooning vehicles, state Information of an inter-vehicle distance control system, or driving or braking information of the platooning vehicle.

As an example, the communication device 110 may receive driving or braking information of a forward vehicle, an emergency braking signal of the forward vehicle, information indicating whether it is possible for the forward vehicle to provide a platoon service, information of the forward vehicle, or the like from the forward vehicle and may receive platooning start or end information from a following vehicle. Furthermore, the communication device 110 may transmit information, such as a vehicle number of the forward vehicle, driving or braking information of the host vehicle, a platooning time, an emergency braking signal or fuel efficiency, to the server 200.

As an example, the communication device 110 may perform inter-vehicle communication with the inter-vehicle distance controller 300, may transmit platooning start or end information, rating information of the forward vehicle, or driving or braking information of the forward vehicle to the inter-vehicle distance controller 300, and may receive platooning start or end information, state information of the host vehicle, inter-vehicle distance setting information of the host vehicle, or the like from the inter-vehicle distance controller 300.

The sensor device 120 may include one or more sensors which detect an obstacle, for example, a preceding vehicle, located around the vehicle and measure a distance from the obstacle and/or a relative speed of the obstacle. Particularly, the sensing device 120 may have a camera for recognizing a vehicle number of the forward vehicle.

The sensing device 120 may have a plurality of sensors to sense outside the vehicle and may obtain information about a location of the object, a speed of the object, a movement direction of the object, and/or a type (e.g., the forward vehicle) of the object. To this end, the sensing device 120 may further include an ultrasonic sensor, a radar, camera, a laser scanner and/or a corner radar, a light detection and ranging (LiDAR), an acceleration sensor, a yaw rate sensor, a torque sensor and/or a wheel speed sensor, a steer angle sensor, or the like.

The interface 130 may include an input means for receiving a control command from a user and an output means for outputting an operation state, an operation result, or the like of the platooning controller 100.

Herein, the input means may include a key button and may further include a mouse, a joystick, a jog shuttle, a stylus pen, or the like. Furthermore, the input means may further include a soft key implemented on a display.

The output means may display a platooning situation (e.g., platoon joining, platoon release, or the like) and information (e.g., a vehicle rating, costs according to the use of a platoon service, or the like) shared from the server 200. The output means may include the display and a voice output means such as a speaker. In this case, when a touch sensor such as a touch film, a touch sheet, or a touch pad is provided in the display, the display operates as a touchscreen and may be implemented in a form where the input means and the output means are integrated with each other.

In this case, the display may include at least one of a liquid crystal display (LCD), a thin film transistor-LCD (TFT-LCD), an organic light-emitting diode (OLED) display, a flexible display, a field emission display (FED), or a three-dimensional (3D) display.

The storage 140 may store information received by the communication device 110, sensing result of the sensing device 120, data obtained by the processor 150, and the like. The storage 140 may store data, an algorithm, and/or the like necessary for an operation of the platooning controller 100.

As an example, the storage 140 may store a vehicle number of the forward vehicle, driving or braking information of the forward vehicle, platooning start or end information of the following vehicle, an emergency braking signal, or the like, which is received through V2V communication.

Furthermore, the storage 140 may store information about a forward vehicle, for example, a vehicle number or the like, which is detected by the sensing device 120.

The storage 140 may include at least one type of storage medium, such as a flash memory type memory, a hard disk type memory, a micro type memory, a card type memory (e.g., a secure digital (SID) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The processor 150 may be electrically connected with the communication device 110, the sensing device 120, the interface 130, the storage 140, and the like and may electrically control the respective components. The processor 150 may be an electrical circuit which executes instructions of software and may perform a variety of data processing and calculation described below. The processor 150 may be, for example, an electronic control unit (ECU), a micro controller unit (MCU), or another sub-controller, which is loaded into the vehicle.

The processor 150 may determine a probability that a forward vehicle will form a platoon during platooning. When it is possible for the forward vehicle to form the platoon, the processor 150 may control an inter-vehicle distance from the forward vehicle depending on a rating of the forward vehicle to perform platooning control. Furthermore, the processor 150 may determine a probability that a following vehicle will form the platoon during platooning. When it is possible for the following vehicle to form the platoon, the processor 150 may transmit platooning information to the following vehicle depending on a role of the host vehicle. In other words, when the host vehicle is a leading vehicle, the processor 150 may transmit platooning information of the host vehicle to following vehicles. When the host vehicle is a following vehicle, the processor 150 may transmit platooning information, received from a leading vehicle, to other platooning vehicles or may request the leading vehicle to share platooning information. Furthermore, when a situation to release the platooning occurs, the processor 150 may automatically release the platooning.

The processor 150 may calculate fuel efficiency according to a role and a platooning time in real time during platooning and may provide the server 200 with the calculated fuel efficiency. Thus, the server 200 may receive fuel efficiency from respective vehicles and may determine the entire fuel efficiency of the platooning service.

The processor 150 may automatically change a platooning route in real time depending on a change in process for platooning. In other words, the processor 150 may automatically change and apply a platooning route depending on platooning joining and release without previously determining a platooning route.

When an inter-vehicle distance control function of the inter-vehicle distance controller 300 is enabled, the processor 150 may recognize a vehicle number of the forward vehicle and may transmit the recognized vehicle number to the server 200, thus receiving information of the forward vehicle (e.g., information indicating whether it is possible for the forward vehicle to use the platooning service, a rating of the forward vehicle, or the like) from the server 200.

The processor 150 may control an inter-vehicle distance from the forward vehicle based on information of the forward vehicle, which is received from the server 200. In other words, the processor 150 may set the inter-vehicle distance to be short, when the rating of the forward vehicle is high, and may set the inter-vehicle distance to be long, when the rating of the forward vehicle is low. In this case, the rating of the forward vehicle may be determined when the server 200 performs registration with the platooning service and may be determined based on fuel efficiency of the forward vehicle, vehicle age of the forward vehicle, fuel of the forward vehicle, or the like.

In case of at least one of when the forward vehicle makes a lane change, when the host vehicle makes a lane change, or when the forward vehicle or the following vehicle is not a vehicle above a predetermined rating, the processor 150 may determine that the situation to release the platooning occurs.

When the situation to release the platooning occurs, the processor 150 may release the platooning and may return the inter-vehicle distance control function to a normal mode. In other words, when increasing or decreasing an inter-vehicle distance, the processor 150 may change the inter-vehicle distance to an inter-vehicle distance upon an original normal mode.

When receiving a request for service registration from the user terminal 400, the server 200 may register vehicle information for platooning.

The server 200 may include a communication device 210, a storage 220, and a processor 230.

The communication device 210 may be a hardware device implemented with various electronic circuits to transmit and receive a signal through a wireless or wired connection, which may communicate with the platooning controller 100 of each of vehicles and the user terminal 400. To this end, the communication device 210 may include wireless local area network (WLAN), wireless broadband (WiBro), wireless-fidelity (Wi-Fi), world interoperability for microwave access (WiMAX), or the like. Furthermore, the short range communication technology may include Bluetooth, ZigBee, ultra wideband (UWB), radio frequency identification (RFID), infrared data association (IrDA), or the like.

As an example, the communication device 210 may receive a vehicle number of a forward vehicle, a platooning time, fuel efficiency of each vehicle, or the like from the platooning controller 100 and may transmit information of the forward vehicle, information indicating whether it is possible for the forward vehicle to use the platooning service, or the like to a vehicle which requests the information of the forward vehicle among platoon vehicles.

As an example, the communication device 210 may receive information, such as vehicle information, platoon role information selected by the user, or a vehicle rating the user prefers, from the user terminal 400 and may provide the user terminal 400 with simple feedback such as information indicating whether it is possible to perform registration with the platooning service. The vehicle information may include sensor configuration information of the host vehicle, a vehicle type (e.g., a gasoline-powered vehicle, a diesel-powered vehicle, or the like), a vehicle number, a function system (e.g., an autonomous driving function) included in the vehicle, or the like. In this case, the vehicle rating may consist of level 2 or more and may be determined with regard to driving pattern of a driver.

The storage 220 may store information, such as corresponding vehicle information received when registration with the platooning service is requested from the user terminal 400, platoon role information selected by the user, or a vehicle rating the user prefers, and a vehicle rating determined by the processor 230. The storage 220 may store a platooning time, fuel efficiency of each vehicle, or the like, which is received from the platooning controller 100 of each vehicle.

The storage 220 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The processor 230 may be electrically connected with the communication device 210, the storage 220, or the like and may electrically control the respective components. The processor 230 may be an electrical circuit which executes instructions of software and may perform a variety of data processing and calculation described below.

The processor 230 may register the vehicle with the platooning service and may settle costs of the platooning service according to the platooning role and the platooning time based on the platooning information received from the platooning vehicles. As an example, the platooning information may include at least one of fuel efficiency of each of the platooning vehicles, a platooning time of the platooning vehicles, braking information of the platooning vehicles, driving information of the platooning vehicles, a platooning start time of the platooning vehicles, or a platooning end time of the platooning vehicles.

The processor 230 may receive vehicle information from the user terminal 500 to determine a vehicle rating. When the vehicle rating is greater than or equal to a predetermined rating or a rating selected by the user, the processor 230 may determine that it is possible for a corresponding vehicle to use the platooning service.

When it is possible for the vehicle to use the platooning service, the processor 230 may receive a selection for a role of the vehicle during platooning from the user terminal 400.

When the vehicle plays a role as a leading vehicle in the string, the processor 230 may pay costs for a user of the leading vehicle. When the vehicle plays a role as a following vehicle in the string, the processor 230 may be paid costs for a user of the following vehicle.

The processor 230 may fail to register a vehicle with a low vehicle rating or a vehicle with low vehicle fuel efficiency upon registration with the platooning service, thus classifying it as a vehicle where it is impossible to use the platooning service.

When the vehicle is a following vehicle, the processor 230 may settle platooning costs of the platooning service based on fuel efficiency of the following vehicle and the platooning time of the following vehicle. When the vehicle is a leading vehicle, the processor 230 may settle costs of the platooning service based on fuel efficiency of a following vehicle behind the leading vehicle and the platooning time of the following vehicle.

The processor 230 may calculate a total of costs of the platooning service based on at least one of a platooning distance, fuel efficiency during platooning, fuel efficiency in a state where the platooning service is not used, or an average oil price.

The processor 230 may calculate a total of costs of the platooning service as Equation 1 below.

Costs of Platooning service={platooning distance*(fuel efficiency while driving−normal fuel efficiency)/(fuel efficiency during platooning*normal fuel efficiency)*average oil price}−service operating costs [Equation 1]

The processor 230 may compare normal fuel efficiency of the vehicle which uses the platooning service with fuel efficiency upon platooning to calculate service costs.

When the vehicle plays both roles as a leading vehicle and a following vehicle, the processor 230 may settle costs of the platooning service based on the number of times each of the roles of the leading vehicle and the following vehicle is performed and a platooning time taken to perform each of the roles of the leading vehicle and the following vehicle.

The inter-vehicle distance controller (e.g., smart cruise control (SCC)) 300 may be an autonomous driving control system, which may control to follow an inter-vehicle distance from a forward vehicle as a set value.

The inter-vehicle distance controller may interwork with an inter-vehicle distance control system. (e.g., SCC) during platooning to minimize an inter-vehicle distance between platooning vehicles, thus reducing air resistance of a following vehicle to obtain the effect of improving fuel efficiency. In this case, to reduce a distance between vehicles, the inter-vehicle distance controller should receive driving and braking information of a forward vehicle through a communication system (V2X) to respond sensitively to provide stability.

The user terminal 400 may receive vehicle information from the user and may transmit the received vehicle information to the server 200.

The user terminal 400 may include all mobile communication terminals, such as a smartphone, a table personal computer (PC), a pad, a personal digital assistant (PDA), and a wearable device, which are capable of being carried and inputting vehicle information by the user.

As such, one form of the present disclosure may automatically perform all levels (e.g., generation, joining, release, and the like) of platooning based on previously registered server information without additional manipulation of the user, thus minimizing restriction on the route because platooning joining or release is free and increasing the range of vehicles capable of performing platooning. In other words, according to another form of the present disclosure, the vehicle equipped with the system capable of performing platooning may perform the platooning irrespective of distinguishing a commercial vehicle from a passenger car or the technical proficiency of the user.

Furthermore, platooning fuel efficiency may increase as the driving range of platooning vehicles and the number of platooning vehicles are increased, and costs according to the platooning service may be automatically calculated in real time to provide cost information to the user. Thus, it is possible to create an added value.

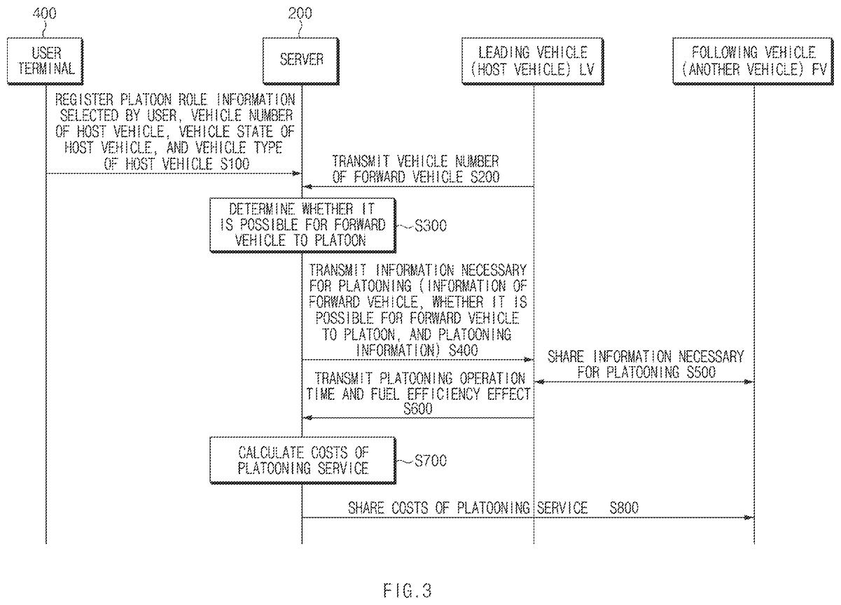

Hereinafter, a description will be given in detail of a platooning control method according to an exemplary form of the present disclosure with reference to FIG. 3. FIG. 3 is a signal sequence diagram illustrating a platooning control method according to one form of the present disclosure. Hereinafter, an operation performed by a user terminal 400 and a server 200 may be understood as being performed by a processor of each of the user terminal 400 and the server 200. An operation performed by a leading vehicle LV and a following vehicle FV may be understood as being performed by a platooning controller loaded into each of the leading vehicle LV and the following vehicle FV.

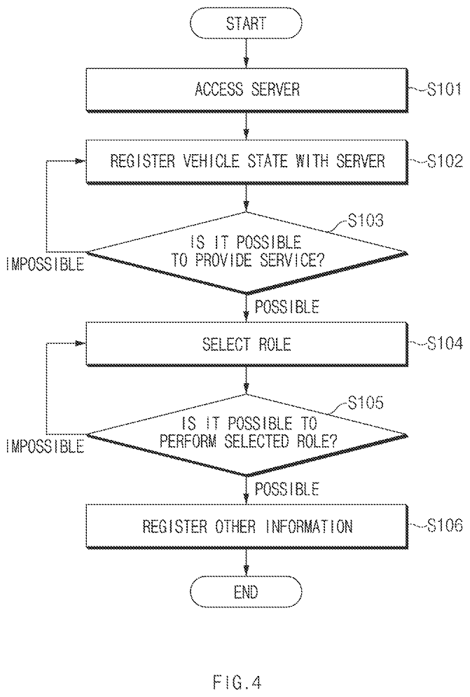

Referring to FIG. 3, in S100, the user terminal 400 may receive platoon role information selected by a user, a vehicle number of a host vehicle, a vehicle state of the host vehicle, or a vehicle type of the host vehicle from the user and may transmit the received information to the server 200 to register the information with a platooning service. In this case, the server 200 may determine a vehicle rating depending on the vehicle state and the vehicle type, may register the vehicle rating, and may share the vehicle rating with platooning vehicles. The platooning service registration process will be described in detail below with reference to FIG. 4.

In S200, the server 200 may receive a vehicle number of a forward vehicle from the platooning vehicles. In this case, in FIG. 3, a description will be given of an example of receiving the vehicle number of the forward vehicle from a leading vehicle LV among the platooning vehicles. Herein, the forward vehicle may refer to a vehicle which is traveling in front of the leading vehicle LV.

In S300, the server 200 may determine whether the forward vehicle is a vehicle registered with the platooning service using the vehicle number of the forward vehicle, which is received from the leading vehicle LV, to determine whether it is possible for the forward vehicle to platoon.

When the forward vehicle is a vehicle capable of performing platooning, in S400, the server 200 may transmit information necessary for the platooning to the leading vehicle LV. As an example, the information necessary for the platooning may include information of the forward vehicle, information indicating whether it is possible to platoon, platooning information, or the like. As an example, the information of the forward vehicle may include a vehicle number of the forward vehicle, a rating of the forward vehicle, information indicating whether it possible for the forward vehicle to use the platooning service, or the like.

The platooning information may include a platooning start or end time, a platooning time, platooning role information, or the like.

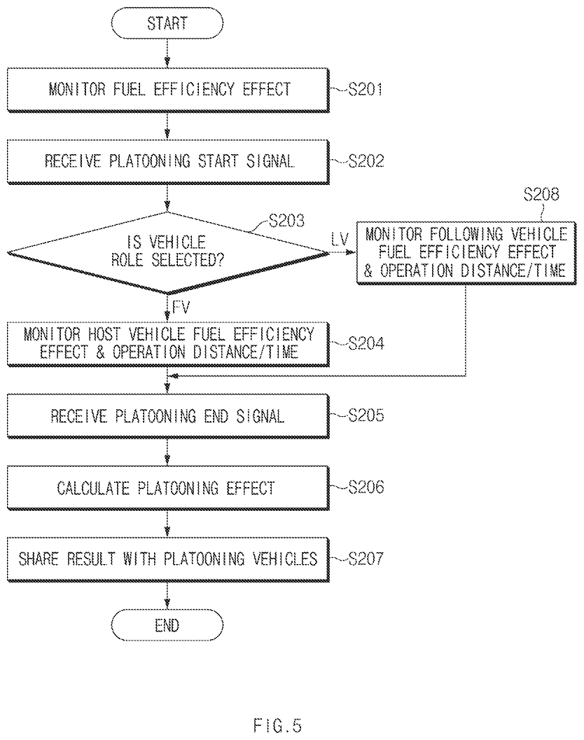

In S500, the leading vehicle may share the information necessary for the platooning with following vehicles. In S600, the leading vehicle may calculate a platooning time and fuel efficiency while the platooning is performed or when the platooning is ended, and may provide the server 200 with the platooning time and the fuel efficiency. In this case, a detailed feature of calculating the fuel efficiency will be described in detail below with reference to FIG. 5.

In S700 and S800, the server 200 may calculate costs of the platooning service based on the platooning time and the fuel efficiency of each vehicle and may share the costs with each vehicle. In this case, the server 200 may differentially apply costs for each platooning role of each vehicle to pay the costs for each vehicle and request to pay the costs.

Hereinafter, a description will be given in detail of a platooning control method according to some forms of the present disclosure with reference to FIG. 4. FIG. 4 is a flowchart illustrating a method for registering vehicle information according to some forms of the present disclosure.

Hereinafter, each of a user terminal 400 and a server 200 of FIG. 1 may perform a process of FIG. 4. Furthermore, in a description of FIG. 4, an operation described as being performed by the user terminal 400 or the server 200 may be understood as being controlled by a processor of the user terminal 400 or the server 200.

In S101, the user terminal 400 may access the server 200. In S102, the user terminal 400 may request the server 200 to register vehicle information for registration with a platooning service. As an example, the vehicle information may include default information, such as sensor configuration of a host vehicle, a vehicle type (e.g., a diesel-powered vehicle, a gasoline-powered vehicle, or the like) of the host vehicle, a vehicle shape of the host vehicle, or a function included in the host vehicle.

In S103, the server 200 may determine whether it is possible for a vehicle which requests registration to use the platooning service and may notify the user terminal 400 of the determined result. In S104, the server 200 may receive a selection of a role (e.g., a leading vehicle, a following vehicle, or the like) in a string from the user terminal 400. In other words, a user may select a leading vehicle LV, a following vehicle FV or both, while the host vehicle performs the platooning service. When the user selects a role of the leading vehicle LV, because the user is a service provider and because the following vehicle FV is mainly close behind the leading vehicle LV to enjoy fuel efficiency, he or she may be paid money corresponding to fuel efficiency from the server 200.

When the user selects a role of the following vehicle FV, because the user is a service user and because the host vehicle travels immediately behind the leading vehicle LV to enjoy a fuel efficiency effect, he or she may pay money for the server 200. When the user selects both the roles of the leading vehicle LV and the following FV, he or she may settle a fee depending on an effect obtained finally when providing or using the service when the host vehicle is sometimes the leading vehicle LV or the following vehicle FV and may be paid or pay the fee.

In S105, the server 200 may determine whether it is possible to perform the selected role in a string. When it is possible to perform the selected role, in S106, the server 200 may register other information.

Such as, in other words, the server 200 may determine whether it is possible for a corresponding vehicle to use the platooning service or whether it is possible to play any of roles, based on information registered by the user and role information selected by the user and may feed back to the user which requests the registration.

Furthermore, the other information may include a condition desired by the user other than default information. For example, the user may select a preferred rating and may exclude a vehicle with a low rating or a vehicle with low fuel efficiency from his or her platooning service use condition depending on a vehicle state.

Hereinafter, a description will be given in detail of a platooning control method according to some forms of the present disclosure with reference to FIG. 5. FIG. 5 is a flowchart illustrating a method for settling a platooning service according to one form of the present disclosure.

Hereinafter, it is assumed that a server 200 of FIG. 1 performs a process of FIG. 5. Furthermore, in a description of FIG. 5, an operation described as being performed by the server 200 may be understood as being controlled by a processor 230 of the server 200.

Referring to FIG. 5, in S201, the server 200 may start to monitor fuel efficiency. When receiving a platooning start signal from each of platooning vehicles in S202, in S203, the server 200 may determine a vehicle role of each of the platooning vehicles. In this case, the server 200 may receive fuel efficiency when the platooning service is not used at a certain period from a platooning controller 100 of each vehicle to monitor the fuel efficiency. In this case, because fuel efficiency is influenced according to a road situation, the server 200 may divide and store the fuel efficiency according to the road situation.

when the host vehicle is a vehicle playing a role as a following vehicle, in S204, the server 200 may monitor fuel efficiency, a driving distance, and a driving time of the host vehicle, which is the following vehicle, until platooning ends alter the platooning stars.

When a platooning end signal is received from each of platooning vehicles in S205, in S206, the server 200 may calculate a platooning effect based on fuel efficiency, a driving distance, a driving time, or the like from each of the platooning vehicles. In S207, the server 200 may transmit the calculated result to the platooning vehicles to share the calculated result with the platooning vehicles.

When the host vehicle is a vehicle playing a role as a leading vehicle, in S204, the server 200 may monitor fuel efficiency, a driving distance, and a driving time of the following vehicle, which is traveling behind the leading vehicle, until platooning ends after the platooning stars. Thereafter, the server 200 may perform S205 to S207.

In other words, when a service user plays a role as a following vehicle FV when using the platooning service, the server 200 may identify fuel efficiency and a driving time of the host vehicle (the following vehicle FV) to settle costs of the platooning service. When the service user plays a role as a leading vehicle LV, the server 200 may identify fuel efficiency and a driving time of a following vehicle FV behind the leading vehicle LV to settle costs of the platooning service.

The server 200 may transmit costs added with regard to a time when the host vehicle travels as the leading vehicle LV or the following vehicle FV, the number of times the host vehicle travels as the leading vehicle LV or the following vehicle FV, or the like to the user in real time depending on a selection of the user.

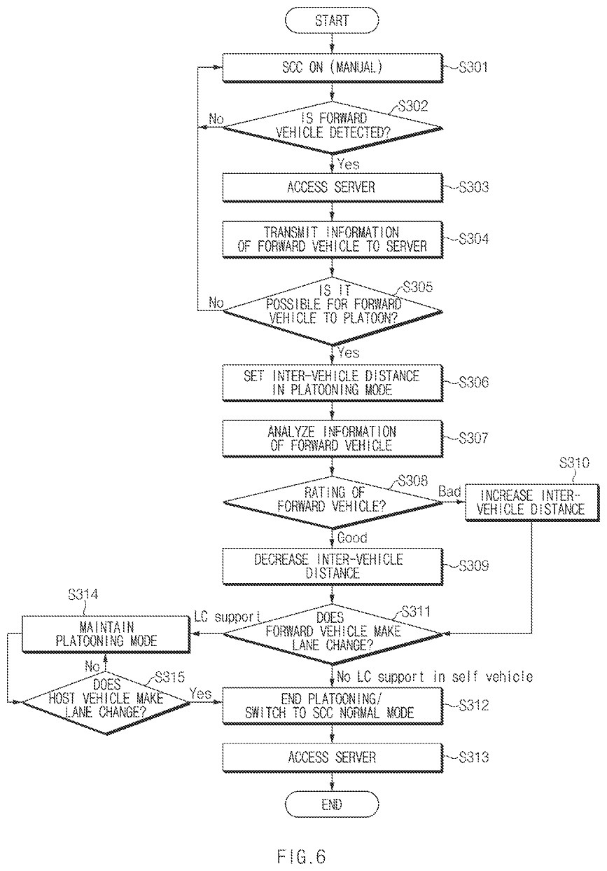

Hereinafter, a description will be given in detail of a platooning control method by a following vehicle according to another form of the present disclosure with reference to FIG. 6. FIG. 6 is a flowchart illustrating a platooning control method by a following vehicle according to one form of the present disclosure.

Hereinafter, an example where a host vehicle is a following vehicle and approaches a leading vehicle LV is disclosed. Hereinafter, it is assumed that a platooning controller 100 of FIG. 1 performs a process of FIG. 6. Furthermore, in a description of FIG. 6, an operation described as being performed by the platooning controller 100 may be understood as being controlled by a processor 150 of the platooning controller 100.

Referring to FIG. 6, when an inter-vehicle distance function SS is turned on in S301, the platooning controller 100 of the host vehicle which is the following vehicle may detect a forward vehicle.

When the forward vehicle is detected, in S303, the platooning controller 100 may access a server 200.

In S304, the platooning controller 100 may transmit information of the forward vehicle to the server 200. As an example, the information of the forward vehicle may include a vehicle number of the forward vehicle.

In S305, the platooning controller 100 may receive information about whether it is possible for the forward vehicle to platoon from the server 200 and may determine whether it is possible for the forward vehicle to platoon. When it is possible for the forward vehicle to platoon, in S306, the platooning controller 100 may set an inter-vehicle distance in a platooning mode. In other words, when it is determined whether it is possible for the forward vehicle to platoon, the platooning controller 100 may identify whether the forward vehicle plays a role as a leading vehicle LV or whether the forward vehicle is a vehicle above a rating selected by a user.

As such, the platooning controller 100 may recognize a vehicle number of the forward vehicle in a state where the SCC is turned on, by accessing the server 200 and may transmit the vehicle number of the forward vehicle to the server 200 to determine whether it is possible for the forward vehicle to platoon.

In S307, the platooning controller 100 may analyze the information of the forward vehicle. In S308, the platooning controller 100 may determine a rating of the forward vehicle. In other words, the platooning controller 100 may analyze the information of the forward vehicle, which is received from the server 200, to determine whether to reduce an inter-vehicle distance to some degree when the forward vehicle travels in the platooning mode. As an example, the information of the forward vehicle may be information previously registered with the server 200 by the user of the forward vehicle, which may include a platoon role of the forward vehicle, a vehicle number of the forward vehicle, a vehicle rating of the forward vehicle, a vehicle type of the forward vehicle. In this case, the vehicle rating of the forward vehicle may be divided into “GOOD” and “BAD”, and the state of the forward vehicle may be determined according to the platoon role of the forward vehicle, the vehicle rating of the forward vehicle, or the vehicle type of the forward vehicle. For example, when the forward vehicle is an old diesel vehicle, the rating of the forward vehicle may be determined as “BAD”. In this case, it is merely illustrative that the vehicle rating is divided into “GOOD” and “BAD”. The vehicle rating may be subdivided and determined as ratings of Level 2 or more. Furthermore, the vehicle rating may be determined according to a driving pattern of a driver as well as the state of the vehicle.

When the rating of the forward vehicle is “GOOD”, in S309, the platooning controller 100 may decrease an inter-vehicle distance. When the rating of the forward vehicle is “BAD”, in S310, the platooning controller 100 may increase the inter-vehicle distance.

After adjusting the inter-vehicle distance, in S311, the platooning controller 100 may determine whether the forward vehicle makes a lane change during platooning.

When the forward vehicle makes a lane change, in S312, the platooning controller 100 may end the platooning and may switch to an SCC normal mode. In S313, the platooning controller 100 may access the server 200 and may transmit a platooning time and fuel efficiency to the server 200.

Meanwhile, when the forward vehicle does not make a lane change, in S314, the platooning controller 100 may maintain the platooning.

Furthermore, when the host vehicle manually makes a lane change, in S312, the platooning controller 100 may end the platooning and may switch to the SCC normal mode.

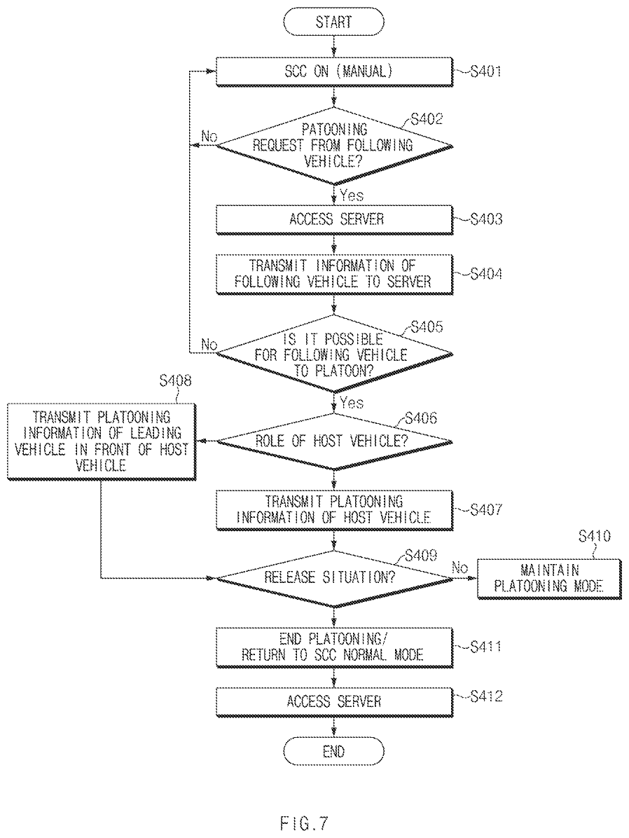

Hereinafter, a description will be given in detail of a platooning control method by a leading vehicle according to an exemplary form of the present disclosure with reference to FIG. 7. FIG. 7 is a flowchart illustrating a platooning control method by a leading vehicle according to one form of the present disclosure.

Hereinafter, an example where a host vehicle is a leading vehicle LV and where the leading vehicle LV approaches a following vehicle FV is disclosed. Hereinafter, it is assumed that a platooning controller 100 of FIG. 1 performs a process of FIG. 7. Furthermore, in a description of FIG. 7, an operation described as being performed by the platooning controller 100 may be understood as being controlled by a processor 150 of the platooning controller 100.

Referring to FIG. 7, when an inter-vehicle distance control function SCC is turned on in S401 and when there is a platooning request from a following vehicle in S402, in S403, a platooning controller 100 of the host vehicle which is the leading vehicle may access a server 200.

In S404, the platooning controller 100 of the host vehicle which is the leading vehicle may transmit information of the following vehicle which requests platooning to the server 200. In S405, the platooning controller 100 may receive information about whether it is possible for the following vehicle to platoon from the server 200 and may determine whether it is possible for the following vehicle to platoon. When it is possible for the following vehicle to platoon, in S406, the platooning controller 100 may determine whether the host vehicle plays a role as the leading vehicle or the following vehicle. When the host vehicle plays a role as the leading vehicle, in S407, the platooning controller 100 may transmit platooning information of the host vehicle to the following vehicle. In this case, when the following vehicle is not a vehicle above a rating selected by a user of the host vehicle based on information of the following vehicle, which is received from the server 200, the platooning controller 100 may determine that it is impossible for the following vehicle to platoon.

Furthermore, when the host vehicle plays a role as the following vehicle, in S408, the platooning controller 100 may transmit platooning information received from a leading vehicle in front of the host vehicle to a following vehicle. In this case, when the host vehicle is a leading vehicle LV there is no vehicle in front of, the platooning controller 100 may transmit braking information of the host vehicle to a following vehicle. When the host vehicle is a following vehicle FV, the platooning controller 100 may transmit platooning information of a leading vehicle LV, which is received from the leading vehicle LV in front of the host vehicle, to a following vehicle or may request the leading vehicle LV to directly transmit the platooning information of the leading vehicle LV to the following vehicle.

In S409, the platooning controller 100 may determine whether a situation to release the platooning occurs. When the situation to release the platooning does not occur, in S410, the platooning controller 100 may maintain a platooning mode. When the situation to release the platooning occurs, in S411, the platooning controller 100 may end the platooning mode to return to an SCC normal mode. In this case, the situation to release the platooning may include when the platooning is released because the host vehicle makes a lane change in the state where it is the most vehicle LV or because the following vehicle makes a lane change. The platooning controller 100 may settle the effect of the service in real time when releasing the platooning.

In S412, the platooning controller 100 may access the server 200 to transmit a platooning time and fuel efficiency to the server 200.

As such, in the existing technology, the user should request or approve a process for platooning every time during the platooning. In other words, in the existing technology, a role of the host vehicle is preset for platooning to be changed every time according to platooning formation, and, when a user of the host vehicle recognizes a forward vehicle to request the forward vehicle to perform platooning and when the forward vehicle approves the request, the host vehicle travels manually to suit a platooning condition and joins a string. However, another form of the present disclosure may previously determine a role a host vehicle prefers or may perform to perform platooning to perform the role automatically depending on situations without the necessity of change when forming platooning and may allow the system to automatically perform joining without particular manual manipulation of the user during joining as soon as it recognizes a forward vehicle, thus increasing convenience of the user.

Furthermore, in the existing technology, to release platooning during the platooning, the user requests a forward vehicle to release the platooning and the forward vehicle should approve the request to release the platoon. However, in one form of the present disclosure, it is possible to automatically release platooning on the system without particular, additional recognition of the user upon release of the platooning.

Furthermore, in the existing technology, a route for platooning should be previously determined to improve the effect of platooning and it is unable to identify the effect of platooning in real time. However, in another form of the present disclosure, because joining and release are automatically performed, the route may be frequently determined without the necessity of previously determining the route, and the effect which occurs during platooning may be settled and displayed in real time, thus more increasing convenience of the user and increasing efficiency of platooning.

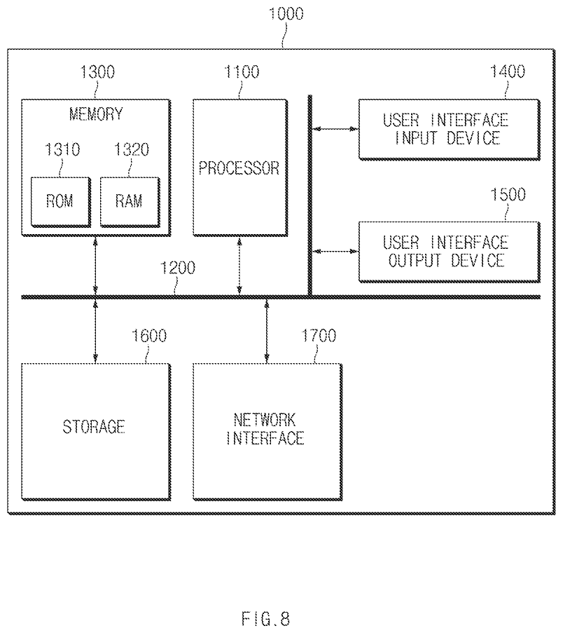

FIG. 8 is a block diagram illustrating a computing system according to another form of the present disclosure.

Referring to FIG. 8, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the forms disclosed herein may be embodied directly in hardware or a software module executed by the processor, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor, and the processor may read information out of the storage medium and may record information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

The present technology may automatically perform all levels of the platooning service without additional manipulation of the driver based on platooning vehicle information previously registered with the server.

The present technology may settle costs of the platooning service according to a role, a platooning time, fuel efficiency, or the like of each of platooning vehicles in real time to differentially pay costs, thus increasing convenience of the user and platooning service efficiency.

In addition, various effects ascertained directly or indirectly through the present disclosure may be provided.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

Therefore, the exemplary forms of the present disclosure ire provided to explain the spirit and scope of the present disclosure, but not to limit them, so that the spirit and scope of the present disclosure is not limited by the forms. The scope of the present disclosure should be construed on the basis of the accompanying claims, and all the technical ideas within the scope equivalent to the claims should be included in the scope of the present disclosure.

What is claimed:

1. A platooning controller, comprising:
a non-transitory memory storing data and instructions executable process a platoon for vehicle;
a processor configured to execute the instructions to:
automatically perform a process for platooning the vehicles;
determine a probability that a forward vehicle will form the platoon;
control an inter-vehicle distance from the forward vehicle based on a state of the forward vehicle, when it is possible for the forward vehicle to form the platoon;
determine a probability that a following vehicle will form the platoon;
transmit platooning information to the following vehicle based on a role of a host vehicle, when it is possible for the following vehicle to form the platoon; and
automatically release at least one of the forward vehicle or the following vehicle from the platoon, when a situation to release the platoon occurs.

2. The platooning controller of claim 1, wherein the processor is configured to calculate fuel efficiency based on a role of the at least one of the forward vehicle or the following vehicle and a platooning time in real time while driving in the platoon.

3. The platooning controller of claim 1, wherein the processor is configured to automatically change a platooning route in real time based on a change in the process for the platooning.

4. The platooning controller of claim 1, wherein the processor is configured to recognize a vehicle number of the forward vehicle and transmit the recognized vehicle number to a server, when an inter-vehicle distance control function is enabled.

5. The platooning controller of claim 1, wherein the processor is configured to control the inter-vehicle distance from the forward vehicle based on information of the forward vehicle received from a server.

6. The platooning controller of claim 1, wherein:
the processor is configured to determine that the situation to release the platoon, and
the situation includes at least one of followings:
when the forward vehicle makes a lane change,
when the host vehicle makes a lane change, and
when the forward vehicle or the following vehicle is not a vehicle above a predetermined rating.

7. The platooning controller of claim 1, wherein the processor is configured to release the platooning and return an inter-vehicle distance control function to a normal mode, when the situation to release the platoon occurs.

8. The platooning controller of claim 1, further comprising:
a sensing device configured to recognize a vehicle number of the forward vehicle and deliver the recognized vehicle number to the processor; and
an interface configured to display a platooning situation and costs according to use of a platooning service, the costs being received from a server.

9. A server, comprising:
a processor configured to perform management for platooning; and
a non-transitory memory storing data obtained by the processor and instructions executed by the processor,
wherein the processor is configured to:
register a vehicle with a platooning service and settle costs of the platooning service according to a platooning role and a platooning time based on platooning information received from platooning vehicles.

10. The server of claim 9, wherein the platooning information includes at least one of fuel efficiency of each of the platooning vehicles, a platooning time of the platooning vehicles, braking information of the platooning vehicles, driving information of the platooning vehicles, a platooning start time of the platooning vehicles, or a platooning end time of the platooning vehicles.

11. The server of claim 9, wherein the processor is configured to determine whether it is possible for the vehicles to use the platooning service, when receiving a state of the vehicles from a user terminal.

12. The server of claim 11, wherein the processor is configured to receive a selection for a role of the vehicles during platooning from the user terminal, when it is possible for the vehicles to use the platooning service.

13. The server of claim 9, wherein:
when a vehicle among the vehicles plays a role as a leading vehicle, the processor is configured to pay the costs for a user of the leading vehicle, and
when the vehicle plays a role as a following vehicle, the processor is configured to receive the costs from a user of the following vehicle.

14. The server of claim 9, wherein the processor is configured to:
receive and register vehicle information, role information during platooning, or a preferred rating of the vehicle from a user terminal, and
determine a rating of the vehicles based on the vehicle information, and
wherein the vehicle information includes at least one of sensor configuration of the vehicles, a shape of the vehicles, or fuel efficiency of the vehicles.

15. The server of claim 14, wherein the processor is configured to determine that it is impossible for a vehicle to use the platooning service, when a rating of the vehicle is less than or equal to the preferred rating received from the user terminal.

16. The server of claim 9, wherein:
when a vehicle among the vehicles is defined as a following vehicle or a leading vehicle, the processor is configured to settle the costs of the platooning service based on fuel efficiency of the following vehicle and a platooning time of the following vehicle.

17. The server of claim 9, wherein the processor is configured to calculate the costs of the platooning service by comparing fuel efficiency in a normal driving with the fuel efficiency in platoon driving.

18. The server of claim 9, wherein when a vehicle among the vehicles plays both roles as a leading vehicle and a following vehicle, the processor is configured to settle the costs of the platooning service based on a respective number of times that the vehicle plays as the leading vehicle and the following vehicle, and a platooning time taken to perform each of the roles of the leading vehicle and the following vehicle.

19. The server of claim 14, further comprising:
a communication device configured to share costs of the platooning service and the rating of the vehicle with the platooning vehicles.

20. A platooning control method, comprising:
registering a vehicle with a platooning service;
settling costs of the platooning service based on a platooning role and a platooning time based on platooning information received from platooning vehicles; and
sharing the costs of the platooning service with the platooning vehicles.
